(19) United States
(12) Patent Application Publication
(10) Pub. No.: US 2024/0388214 A1
(43) Pub. Date: Nov. 21, 2024

(54) Power Conversion Device and Method of Manufacturing Power Conversion Device

(71) Applicant: Mitsubishi Electric Corporation, Chiyoda-ku, Tokyo (JP)

(72) Inventors: Yukiko MORI, Chiyoda-ku, Tokyo (JP); Kenta FUJII, Chiyoda-ku, Tokyo (JP); Yoshikazu TSUNODA, Chiyoda-ku, Tokyo (JP); Takashi KUMAGAI, Chiyoda-ku, Tokyo (JP); Yuji SHIRAKATA, Chiyoda-ku, Tokyo (JP); Norikazu HATTORI, Chiyoda-ku, Tokyo (JP); Yoshimichi SAITO, Chiyoda-ku, Tokyo (JP)

(73) Assignee: Mitsubishi Electric Corporation, Chiyoda-ku, Tokyo (JP)

(21) Appl. No.: 18/692,178

(22) PCT Filed: Sep. 14, 2022
(86) PCT No.: PCT/JP2022/034413

§ 371 Date: Mar. 14, 2024

(30) Foreign Application Priority Data
Sep. 28, 2021 (JP) 2021-158121

(51) Int. Cl. H02M 7/00; H01G 2/08; H01G 2/10; H01G 4/32; H02M 7/48

(52) U.S. Cl. CPC H02M 7/003; H01G 2/08; H01G 2/10; H02M 7/48; H01G 4/32

(57) ABSTRACT

A power conversion device includes a housing, a plurality of circuit components accommodated in the housing, at least one heat dissipation plate accommodated in the housing, and a substrate. Each of the plurality of circuit components includes an element body and a current-carrying terminal electrically connected to an electrode surface of the element body. The substrate is electrically connected to the current-carrying terminal. The at least one heat dissipation plate is disposed between two adjacent circuit components of the plurality of circuit components and thermally connected to the housing.

### TECHNICAL FIELD

The present disclosure relates to a power conversion device and a method of manufacturing the power conversion device.

### BACKGROUND ART

Japanese Patent Laying-Open No. 2016-66666 (PTL 1) discloses a capacitor. The capacitor disclosed in PTL 1 includes a case, a capacitor element, an electrode plate, a mold resin, and a lid body. The capacitor element and the electrode plate are accommodated in the case. The capacitor element has a lead terminal electrically connected to the electrode plate. The molding resin fills the case. Thus, the capacitor element and the electrode plate are sealed in the case. The lid body is attached to an opening of the case.

### CITATION LIST

### Patent Literature

PTL 1: Japanese Patent Laying-Open No. 2016-66666

### SUMMARY OF INVENTION

### Technical Problem

In the capacitor disclosed in PTL 1, heat generated in the capacitor element is transferred through the lead terminal and the electrode plate to the lid body and dissipated from a protrusion of the lid body. Thus, the capacitor disclosed in PTL 1 has a large thermal resistance, and thus, the temperature rise in the capacitor element increases.

The present disclosure has been made in view of the above-described problem of the conventional art. More specifically, the present disclosure aims to provide a power conversion device capable of suppressing a temperature rise in a circuit component.

### Solution to Problem

A power conversion device of the present disclosure includes: a housing: a plurality of circuit components accommodated in the housing: at least one heat dissipation plate accommodated in the housing: and a substrate. Each of the plurality of circuit components includes an element body and a current-carrying terminal electrically connected to an electrode surface of the element body. The substrate is electrically connected to the current-carrying terminal. The at least one heat dissipation plate is disposed between two adjacent circuit components of the plurality of circuit components and thermally connected to the housing.

### Advantageous Effects of Invention

According to the power conversion device of the present disclosure, a temperature rise in the circuit component can be suppressed.

### BRIEF DESCRIPTION OF DRAWINGS

FIG. 1 is a circuit diagram of a power conversion device 100.

FIG. 2 is a perspective view of power conversion device 100.

FIG. 3 is an exploded perspective view of power conversion device 100.

FIG. 4 is a cross-sectional view taken along a line IV-IV in FIG. 2.

FIG. 5 is a plan view of power conversion device 100 in which a substrate 60 is not shown.

FIG. 6 is an enlarged cross-sectional view of substrate 60.

FIG. 7 is a process diagram showing a method of manufacturing power conversion device 100.

FIG. 8 is a cross-sectional view of a power conversion device 100 according to a first modification.

FIG. 9 is a perspective view of a power conversion device 100 according to a second modification.

FIG. 10 is a perspective view of a power conversion device 100 according to a third modification.

FIG. 11 is a plan view of a power conversion device 100 according to a fourth modification in which substrate 60 is not shown.

FIG. 12 is a plan view of a power conversion device 100A in which substrate 60 is not shown.

FIG. 13 is a plan view of a power conversion device 100A according to a first modification in which substrate 60 is not shown.

FIG. 14 is a plan view of a power conversion device 100A according to a second modification in which substrate 60 is not shown.

FIG. 15 is a plan view of a substrate 60 included in a power conversion device 100B.

FIG. 16 is an enlarged cross-sectional view of power conversion device 100B.

FIG. 17 is a bottom view of a substrate 60 included in a power conversion device 100B according to a first modification.

FIG. 18 is an enlarged cross-sectional view of power conversion device 100B according to the first modification.

FIG. 19 is an enlarged cross-sectional view of a power conversion device 100B according to a second modification.

FIG. 20 is a side view of a heat dissipation plate 40 included in a power conversion device 100C.

FIG. 21 is a plan view of a substrate 60 included in power conversion device 100C.

FIG. 22 is a cross-sectional view of a power conversion device 100D.

FIG. 23 is one example of a side view of a heat dissipation plate 40 included in a power conversion device 100D according to a first modification.

FIG. 24 is another example of the side view of heat dissipation plate 40 included in power conversion device 100D according to the first modification.

FIG. 25 is one example of a cross-sectional view of a power conversion device 100D according to a second modification.

FIG. 26 is another example of the cross-sectional view of power conversion device 100D according to the second modification.

### DESCRIPTION OF EMBODIMENTS

The details of embodiments of the present disclosure will be described with reference to the accompanying drawings. In the accompanying drawings, the same or corresponding portions are denoted by the same reference characters, and the description thereof will not be repeated.

### First Embodiment

A power conversion device according to the first embodiment will be described. The power conversion device according to the first embodiment will be referred to as a power conversion device 100.

### Configuration of Power Conversion Device 100

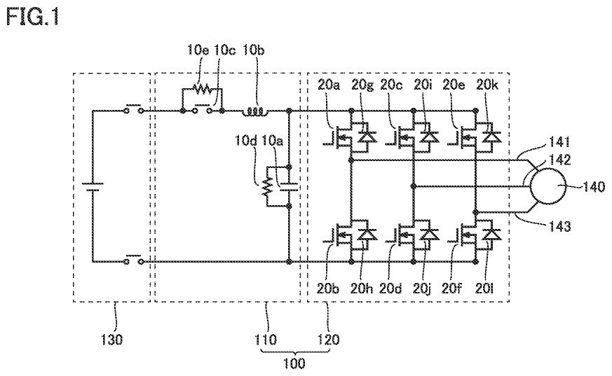

The configuration of power conversion device 100 will be described below. FIG. 1 is a circuit diagram of power conversion device 100. As shown in FIG.

1, power conversion device 100 includes a peripheral circuit 110 and a switching circuit 120.

Peripheral circuit 110 includes a plurality of circuit components 10. In the example shown in FIG. 1, the plurality of circuit components 10 are a capacitor 10a, an inductor 10b, a contactor 10c, a discharge resistor 10d, and a charge resistor 10e. Capacitor 10a, inductor 10b, and contactor 10c are connected in series. Inductor 10b is disposed between capacitor 10a and contactor 10c. Discharge resistor 10d and charge resistor 10e are connected in parallel to capacitor 10a and contactor 10c, respectively. Peripheral circuit 110 is connected to a direct-current (DC) supply circuit 130.

Switching circuit 120 is a three-phase inverter circuit, for example. Switching circuit 120 includes a plurality of circuit components 20. In the example shown in FIG. 1, the plurality of circuit components 20 are transistors 20a to 20f and diodes 20g to 201.

Transistor 20a has a drain electrically connected to one electrode of capacitor 10a. Transistor 20a has a source electrically connected to a drain of transistor 20b. Transistor 20b has a source electrically connected to the other electrode of capacitor 10a.

Diode 20g has an anode electrically connected to the source of transistor 20a. Diode 20g has a cathode electrically connected to the drain of transistor 20a. Diode 20h has an anode electrically connected to the source of transistor 20b. Diode 20h has a cathode electrically connected to the drain of transistor 20b.

Note that transistor 20c, transistor 20d, diode 20i, and diode 20j are connected in a manner similar to transistor 20a, transistor 20b, diode 20g, and diode 20h, respectively. Transistor 20e, transistor 20f, diode 20k, and diode 20are connected in a manner similar to transistor 20a, transistor 20b, diode 20g, and diode 20h, respectively. Although not shown, transistors 20a to 20f each have a gate connected to a control circuit.

Switching circuit 120 is connected to a motor 140. Motor 140 is a three-phase motor, for example. Motor 140 has input lines 141, 142, and 143. Input line 141 is electrically connected to the source of transistor 20a and the drain of transistor 20b. Input line 142 is electrically connected to a source of transistor 20c and a drain of transistor 20d. Input line 143 is electrically connected to a source of transistor 20e and a drain of transistor 20f.

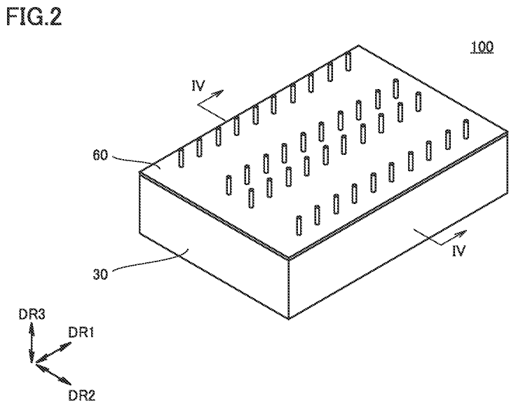

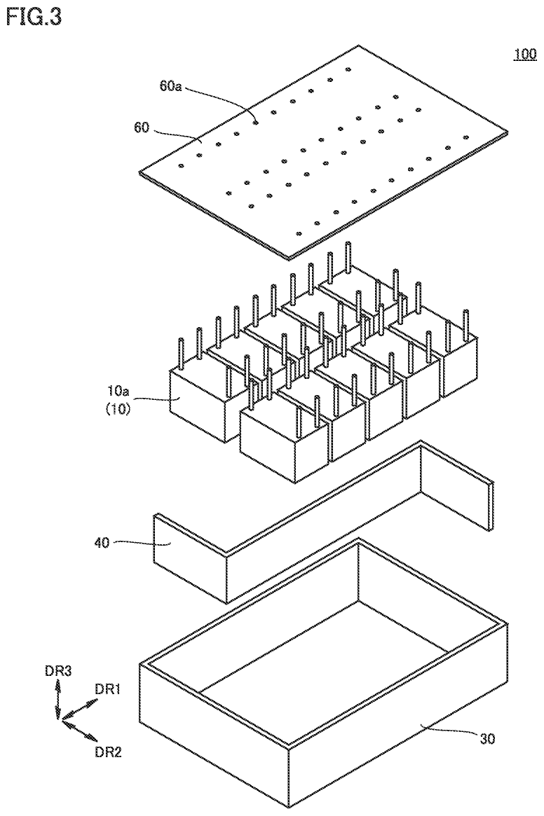

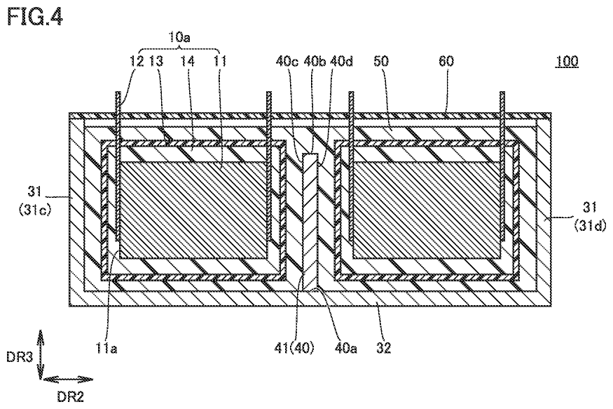

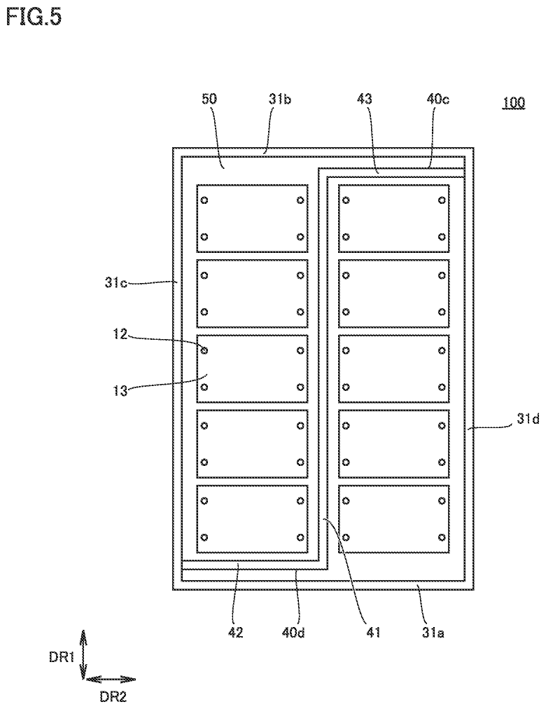

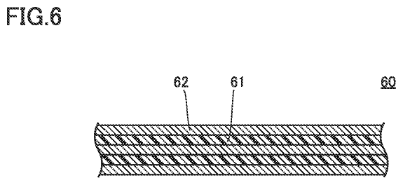

FIG. 2 is a perspective view of power conversion device 100. FIG. 3 is an exploded perspective view of power conversion device 100. FIG. 4 is a cross-sectional view taken along a line IV-IV in FIG. 2. FIG. 5 is a plan view of power conversion device 100 in which a substrate 60 is not shown. FIG. 6 is an enlarged cross-sectional view of substrate 60. As shown in FIGS. 2 to 6, power conversion device 100 includes a plurality of circuit components 10, a housing 30, a heat dissipation plate 40, a heat transfer member 50, and substrate 60.

Housing 30 has a side wall 31 and a bottom wall 32. Side wall 31 has a first side wall portion 31a, a second side wall portion 31b, a third side wall portion 31c, and a fourth side wall portion 31d. First side wall portion 31a and second side wall portion 31b face each other at a distance therebetween in a first direction DR1. Third side wall portion 31c and fourth side wall portion 31d face each other at a distance therebetween in a second direction DR2. Second direction DR2 is orthogonal to first direction DR1. Side wall 31 is, for example, rectangular in a plan view. Bottom wall 32 is contiguous to a lower end of side wall 31.

Housing 30 is made of a rigid material. Housing 30 is made, for example, of a metal material. Housing 30 is made of any metal material selected from the group consisting of copper (Cu), a copper alloy, aluminum (Al), an aluminum alloy, iron (Fe), and an iron alloy. Specific examples of the copper alloy include phosphor bronze, specific examples of the aluminum alloy include ADC12 defined in JIS standard, and specific examples of the iron alloy include SUS304.

Housing 30 may be made of a resin material. The resin material is any one selected from the group consisting of, for example, polybutylene terephthalate (PBT), polyphenylene sulfide (PPS), and polyetheretherketone (PEEK). The resin material may contain a thermally conductive filler. Housing 30 is preferably formed of a non-magnetic material.

Housing 30 is formed, for example, by cutting, die casting, or forging. Housing 30 may be formed by sheet metal pressing and welding. Housing 30 may be formed by molding using a mold.

In the example shown in FIGS. 2 to 6, circuit component 10 is capacitor 10a. Capacitor 10a is an element that accumulates or discharges electric charge. Capacitor 10a is a film capacitor, for example. Circuit component 10 includes an element body and a current-carrying terminal. When circuit component 10 is capacitor 10a, the element body is a capacitor element 11, and the current-carrying terminal is a current-carrying terminal 12. Capacitor 10a further includes an outer case 13 and a resin 14.

Capacitor element 11 is formed, for example, by winding a metal film and a dielectric film disposed on the metal film. The dielectric film is a plastic film, for example. The plastic film is made, for example, of polyethylene terephthalate (PET), polyphenylene sulfide, polypropylene (PP), polyethylene naphthalate (PEN), polycarbonate (PC), polytetrafluoroethylene (PTFE), or the like.

The plastic film is preferably made of polyethylene terephthalate from the viewpoint of manufacturing cost, and preferably made of polypropylene from the viewpoint of high-frequency characteristics. The plastic film is preferably made of polyphenylene sulfide from the viewpoint of thermal resistance and high-frequency characteristics, and preferably made of polyethylene naphthalate from the viewpoint of size reduction and thermal resistance. The plastic film is preferably made of polytetrafluoroethylene from the viewpoint of thermal resistance.

The capacitance of capacitor 10a is proportional to the dielectric constant and the area of the dielectric film, and inversely proportional to the distance between the metal films. The dielectric film accumulates electric charge.

Capacitor element 11 has both end surfaces each formed as an electrode surface 11a to which current-carrying terminal 12 is electrically connected. Electrode surface 11a may be formed by evaporating a metal onto a plastic film. Current-carrying terminal 12 serves to cause a current received from outside to flow through capacitor element 11. Current-carrying terminal 12 extends in a third direction DR3. Third direction DR3 is orthogonal to first direction DR1 and second direction DR2.

Current-carrying terminal 12 is made of a conductive material. Current-carrying terminal 12 is made, for example, of copper, a copper alloy, silver (Ag), a silver alloy, gold (Au), a gold alloy, tin (Sn), a tin alloy, a nickel (Ni) alloy, aluminum, titanium (Ti), or molybdenum (Mo). Current-carrying terminal 12 preferably has a surface on which a plating layer made of chromium (Cr), nickel, copper, tin, silver, zinc (Zn), gold, or the like is formed from the viewpoint of improvement in corrosion resistance, thermal resistance, and electric conductivity.

Outer case 13 is made of an insulating material. Outer case 13 is made, for example, of a resin material. Outer case 13 is made, for example, of a resin material selected from the group consisting of polypropylene, poly butylene terephthalate, polyphenylene sulfide, and polyetheretherketone. Capacitor element 11 and current-carrying terminal 12 are accommodated in outer case 13. Note that a part of current-carrying terminal 12 protrudes from the upper surface of outer case 13. Outer case 13 insulates capacitor element 11 from the surroundings and prevents intrusion of substances such as air or moisture, which changes the electrostatic induction effect, into capacitor element 11.

Resin 14 has electrically insulating properties. Resin 14 is preferably a heat-

resistant resin. Specific examples of resin 14 include an epoxy resin and a tape wrap resin. Resin 14 fills outer case 13. Thereby, capacitor element 11 and current-carrying terminal 12 are sealed, and capacitor element 11 is insulated from the outside. The bottom surface of capacitor 10a (the bottom surface of outer case 13) may or may not be in contact with bottom wall 32.

The plurality of capacitors 10a are accommodated in housing 30. In the example shown in FIGS. 2 to 6, the plurality of capacitors 10a are arranged in two columns (the first column and the second column) in first direction DR1. Electrode surface 11a of capacitor 10a belonging to the first column faces electrode surface 11a of capacitor 10a belonging to the second column.

Heat dissipation plate 40 is accommodated in housing 30. Heat dissipation plate 40 has a lower end 40a and an upper end 40b. Lower end 40a and upper end 40b correspond to both ends of heat dissipation plate 40 in third direction DR3. Lower end 40a is in contact with bottom wall 32. However, lower end 40a may not be in contact with bottom wall 32. Upper end 40b is an end opposite to lower end 40a.

Heat dissipation plate 40 has side surfaces 40c and 40d. Side surfaces 40c and 40d are end surfaces of heat dissipation plate 40 in the thickness direction. Side surface 40d is located opposite to side surface 40c. Side surfaces 40c and 40d each have an arithmetic average roughness of preferably 6.3 μm or more.

Heat dissipation plate 40 includes a first portion 41, a second portion 42, and a third portion 43 in a plan view. First portion 41 extends in first direction DR1. First portion 41 is disposed between the plurality of capacitors 10a arranged in the first column and the plurality of capacitors 10a arranged in the second column. In other words, electrode surface 11a of each of capacitors 10a arranged in the first column faces side surface 40c in first portion 41, and electrode surface 11a of each of capacitors 10a arranged in the second column faces side surface 40d in first portion 41. The side surface of outer case 13 may or may not be in contact with first portion 41.

Electrode surface 11a on the first portion 41 side in capacitor 10a belonging to the first column (the second column) is preferably substantially parallel to side surface 40c (side surface 40d) of first portion 41. Electrode surface 11a on the side opposite to first portion 41 in capacitor 10a belonging to the first column (the second column) is preferably substantially parallel to the inner wall surface of third side wall portion 31c (fourth side wall portion 31d). The bottom surface of capacitor 10a is preferably substantially parallel to the inner wall surface of bottom wall 32. Note that the configuration in which two surfaces are substantially parallel to each other means that the angle formed by these two surfaces is within a range of ±5° or less.

Second portion 42 extends in second direction DR2 from one end of first portion 41 in first direction DR1 toward third side wall portion 31c. Third portion 43 extends in second direction DR2 from the other end of first portion 41 in first direction DR1 toward fourth side wall portion 31d. Heat dissipation plate 40 is bent at a connection portion between first portion 41 and second portion 42 and at a connection portion between first portion 41 and third portion 43. From a different point of view, heat dissipation plate 40 has bent portions including: the connection portion between first portion 41 and second portion 42: and the connection portion between first portion 41 and third portion 43. Side surface 40d of second portion 42 faces side wall 31 (first side wall portion 31a). Side surface 40c of third portion 43 faces side wall 31 (second side wall portion 31b).

The material of heat dissipation plate 40 may be the same as or different from the material of housing 30. Heat dissipation plate 40 is formed, for example, by cutting, die casting, or forging. Heat dissipation plate 40 may be formed by sheet metal pressing and welding. Heat dissipation plate 40 may be formed by molding using a mold.

The width of heat dissipation plate 40 in second direction DR2 is, for example, larger than the width of heat dissipation plate 40 in first direction DR1. The width of heat dissipation plate 40 in second direction DR2 is most preferably equal to the distance in second direction DR2 between third side wall portion 31c and fourth side wall portion 31d. The value obtained by subtracting the width of heat dissipation plate 40 in second direction DR2 from the distance in second direction DR2 between third side wall portion 31c and fourth side wall portion 31d may be smaller than 0.5 mm.

Heat transfer member 50 is a potting material made of an electrically insulating material. Heat transfer member 50 is, for example, made of a resin material. Examples of the resin material are silicone, urethane, epoxy, and the like. The resin material may contain a thermally conductive filler. Heat transfer member 50 preferably has curing properties or adhesive properties. Heat transfer member 50 is preferably resistant to water.

Heat transfer member 50 is disposed in housing 30. Thereby, the plurality of capacitors 10a and heat dissipation plate 40 are sealed in housing 30, and capacitors 10a are thermally connected to heat dissipation plate 40. Heat transfer member 50 is preferably disposed such that outer case 13 is embedded in heat transfer member 50. However, current-carrying terminal 12 protrudes from heat transfer member 50. Heat transfer member 50 is not in contact with substrate 60, but there is a gap between heat transfer member 50 and substrate 60. Upper end 40b is located below the upper surface of heat transfer member 50. In other words, heat dissipation plate 40 is embedded in heat transfer member 50.

Substrate 60 is a printed circuit board, for example. A plurality of base members 61 and a plurality of wiring members 62 are provided. Base members 61 and wiring members 62 are alternately stacked in the thickness direction of substrate 60. Base member 61 is made of an electrically insulating material. Base member 61 is made, for example, of epoxy, a phenolic resin, polyphenylene sulfide, polyetheretherketone, or the like containing glass-reinforced fibers.

Wiring member 62 is made of a conductive material, i.e., a material having low electrical resistivity and high thermal conductivity. Wiring member 62 is made, for example, of copper, a copper alloy, silver, a silver alloy, gold, a gold alloy, tin, a tin alloy, a nickel alloy, or the like. The thickness of wiring member 62 is, for example, 1 μm or more and 5000 μm or less.

Substrate 60 is provided with a through hole 60a. Although not shown, a conductor layer 63 is formed on the inner wall surface of through hole 60a. Current-carrying terminal 12 is introduced to pass through the through hole 60a and a bonding member 64 (not shown) is disposed between conductor layer 63 and current-carrying terminal 12, so that current-carrying terminal 12 is electrically connected to wiring member 62. Bonding member 64 is a solder alloy, for example. Current-carrying terminal 12 may be connected to wiring member 62 provided on the surface of substrate 60. Electronic components constituting a control circuit are arranged on substrate 60. Substrate 60 may be a ceramic substrate or a metal substrate. Substrate 60 is preferably in contact with side wall 31.

### Method of Manufacturing Power Conversion Device 100

A method of manufacturing power conversion device 100 will be described below.

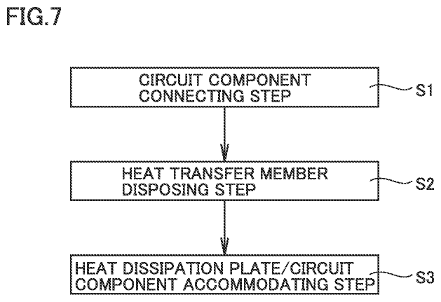

FIG. 7 is a process diagram showing a method of manufacturing power conversion device 100. As shown in FIG. 7, a method of power conversion device 100 includes a circuit component connecting step S1, a heat transfer member disposing step S2, and a heat dissipation plate/circuit component accommodating step S3.

In circuit component connecting step S1, capacitor 10a and substrate 60 are electrically connected to each other. Capacitor 10a and substrate 60 are electrically connected, for example, by soldering. Heat transfer member disposing step S2 is performed after circuit component connecting step S1. In heat transfer member disposing step S2, heat transfer member 50 is disposed in housing 30.

Heat dissipation plate/circuit component accommodating step S3 is performed after heat transfer member disposing step S2. In heat dissipation plate/circuit component accommodating step S3, heat dissipation plate 40 is accommodated in housing 30. In heat dissipation plate/circuit component accommodating step S3, the plurality of capacitors 10a are also accommodated in housing 30. Thereby, capacitors 10a and heat dissipation plate 40 are thermally connected by heat transfer member 50.

In the above-described example, heat dissipation plate/circuit component accommodating step S3 is performed after heat transfer member disposing step S2, but heat transfer member disposing step S2 may be performed after heat dissipation plate/circuit component accommodating step S3.

### Effects of Power Conversion Device 100

When an alternating-current (AC) current flows through capacitor 10a while power conversion device 100 is operating, power consumption occurs due to a resistance component of capacitor 10a, and capacitor 10a generates heat. In this case, the heat generated by capacitor 10a is the heat generated in capacitor element 11 and current-carrying terminal 12.

In power conversion device 100, the plurality of capacitors 10a are densely arranged. The shorter the distance between the adjacent capacitors 10a, the more the heat generated by these adjacent capacitors 10a interferes, and thus, the temperature rise in capacitors 10a increases. An excessive temperature rise in capacitor 10a causes characteristic deterioration, breakage, and shortened life in capacitor 10a.

In power conversion device 100, capacitors 10a and heat dissipation plate 40 are thermally connected by heat transfer member 50. Thus, the heat generated in capacitor 10a is transferred to housing 30 through heat transfer member 50 and heat dissipation plate 40, and then dissipated from bottom wall 32. In this way, according to power conversion device 100, the temperature rise in capacitor 10a can be suppressed.

During energization of capacitor 10a, heat generated in capacitor element 11 is transferred through the metal film and reaches electrode surface 11a. Further, a current concentrates on electrode surface 11a. Thus, capacitor 10a generates heat most significantly at electrode surface 11a. In power conversion device 100, heat dissipation plate 40 (first portion 41) is disposed to face electrode surface 11a of capacitor 10a belonging to the first column and electrode surface 11a of capacitor 10a belonging to the second column, and thereby, electrode surface 11a generating a significant amount of heat can be efficiently cooled, and the temperature rise in capacitor 10a can be further suppressed.

In power conversion device 100, electrode surface 11a on the side opposite to first portion 41 in capacitor 10a belonging to the first column faces side wall 31 (third side wall portion 31c) with heat transfer member 50 interposed therebetween, and electrode surface 11a on the side opposite to first portion 41 in capacitor 10a belonging to the second column faces side wall 31 (fourth side wall portion 31d) with heat transfer member 50 interposed therebetween. Thus, the heat generated in electrode surface 11a can be dissipated also from side wall 31, and the temperature rise in capacitor 10a can be further suppressed.

Since the heat from capacitor 10a on each of the surfaces other than electrode surface 11a is also transferred to side wall 31 or heat dissipation plate 40 through heat transfer member 50, the temperature rise in capacitor 10a can be suppressed.

The temperature is more likely to rise higher in capacitors 10a disposed at positions other than both ends in first direction DR1 than in capacitors 10a disposed at both ends in first direction DR1. In power conversion device 100, heat dissipation plate 40 has first portion 41 extending in first direction DR1. Capacitors 10a disposed at both ends in first direction DR1 and capacitors 10a disposed at portions other than both ends in first direction DR1 are arranged to face first portion 41 with heat transfer member 50 interposed therebetween, and thus, the temperature is equalized between capacitors 10a disposed at both ends in first direction DR1 and capacitors 10a disposed at positions other than both ends in first direction DR1.

The required thermal resistance of capacitors 10a is determined based on capacitor 10a whose temperature most significantly rises. Therefore, power conversion device 100 makes it possible to use a capacitor having low thermal resistance as capacitor 10a.

In power conversion device 100, electrode surface 11a of each capacitor 10a belonging to the first column faces electrode surface 11a of each capacitor 10a belonging to the second column, and heat dissipation plate 40 (first portion 41) is disposed between capacitors 10a belonging to the first column and capacitors 10a belonging to the second column, which eliminates the need to provide a plurality of heat dissipation plates 40, so that the manufacturing cost for power conversion device 100 can be reduced.

In power conversion device 100, heat dissipation plate 40 includes second portion 42 and third portion 43. Side surface 40d of second portion 42 and side surface 40c of third portion 43 face first side wall portion 31a and second side wall portion 31b, respectively. Therefore, in power conversion device 100, the heat of heat dissipation plate 40 is easily transferred to side wall 31 and dissipated from side wall 31, with the result that the temperature rise in capacitor 10a can be further suppressed.

In power conversion device 100, bottom wall 32 is in contact with heat dissipation plate 40, and thus, heat is easily transferred from heat dissipation plate 40 to bottom wall 32, so that the temperature rise in capacitor 10a can be further suppressed. Heat dissipation plate 40 has second portion 42 and third portion 43, and thereby, the area of contact between heat dissipation plate 40 and bottom wall 32 becomes large. The contact thermal resistance between heat dissipation plate 40 and bottom wall 32 decreases as the area of contact between heat dissipation plate 40 and bottom wall 32 increases. Thus, in power conversion device 100, the heat of heat dissipation plate 40 is easily transferred to bottom wall 32 and dissipated from bottom wall 32, so that the temperature rise in capacitor 10a can be further suppressed.

Further, since heat dissipation plate 40 is bent so as to have second portion 42 and third portion 43, heat dissipation plate 40 can be disposed in a freestanding state on bottom wall 32, which eliminates the need to provide a jig for supporting heat dissipation plate 40 used when heat dissipation plate 40 is accommodated in housing 30, with the result that the manufacturing cost for power conversion device 100 can be reduced.

When the width of heat dissipation plate 40 in second direction DR2 is equal to the distance in second direction DR2 between third side wall portion 31c and fourth side wall portion 31d, or when the value obtained by subtracting the width of heat dissipation plate 40 in second direction DR2 from the distance in second direction DR2 between third side wall portion 31c and fourth side wall portion 31d is smaller than 0.5 mm, heat dissipation plate 40 can be positioned in housing 30 by second portion 42 and third portion 43. Positioning of heat dissipation plate 40 facilitates positioning of capacitors 10a, and thus, the assembly performance for power conversion device 100 is improved.

When the arithmetic average roughness in each of side surfaces 40c and 40d is 6.3 μm or more, the area of contact between heat dissipation plate 40 and heat transfer member 50 becomes large, and the contact thermal resistance between heat dissipation plate 40 and heat transfer member 50 becomes small, so that the temperature rise in capacitor 10a can be further suppressed.

In power conversion device 100, capacitor 10a is sealed by heat transfer member 50, which makes it possible to fix the position of capacitor 10a, and also enables protection, dust prevention, and insulation of capacitor 10a. Further, when heat transfer member 50 is disposed in housing 30 such that outer case 13 is embedded in heat transfer member 50, the vibration resistance of power conversion device 100 is improved. In this case, the area of contact between capacitor 10a and heat transfer member 50 increases and the contact thermal resistance between capacitor 10a and heat transfer member 50 decreases, with the result that the temperature rise in capacitor 10a can be further suppressed.

During energization, the heat of capacitor 10a is dissipated to heat transfer member 50. In this case, however, if substrate 60 is located inside heat transfer member 50 (if substrate 60 is sealed by heat transfer member 50), the difference in linear expansion coefficient between heat transfer member 50 and substrate 60 causes application of a stress to substrate 60 and current-carrying terminal 12 upon a temperature change, which causes damage to current-carrying terminal 12 and cracks in a soldering portion connecting current-carrying terminal 12 and substrate 60. In power conversion device 100, a gap is present between heat transfer member 50 and substrate 60 (substrate 60 is not sealed by heat transfer member 50), which makes it possible to suppress damage to current-carrying terminal 12 and cracks in the soldering portion as described above.

When substrate 60 is located inside heat transfer member 50, it becomes difficult to connect other devices to power conversion device 100. In other words, the connection portion mounted on substrate 60 for connection to other devices needs to be disposed so as to be exposed from heat transfer member 50 or another substrate connected to substrate 60 needs to be disposed outside heat transfer member 50. This consequently imposes constraints on the components used in power conversion device 100 and the assembling steps for power conversion device 100. If a gap is present between heat transfer member 50 and substrate 60 (substrate 60 is not sealed by heat transfer member 50), the above-mentioned constraints can be avoided.

If heat transfer member 50 is located in a significantly unbalanced manner in housing 30, the surface that corresponds to the portion including a relatively small amount of heat transfer member 50 and that is thermally connected to housing 30 becomes relatively small, and accordingly, the temperature rise in capacitor 10a may increase. When upper end 40b is located below the upper end of heat transfer member 50, and even if adjacent capacitors 10a are separated by heat dissipation plate 40, heat transfer member 50 before curing moves to thereby facilitate easy alignment of the height of the liquid level of this heat transfer member 50 before curing in heat transfer member disposing step S2, with the result that heat transfer member 50 fills housing 30 in a balanced manner and the temperature in capacitor 10a is equalized.

When electrode surface 11a on the first portion 41 side in capacitor 10a belonging to the first column (the second column) is substantially parallel to side surface 40c (side surface 40d) in first portion 41, the thermal resistance between electrode surface 11a and heat dissipation plate 40 can be equalized. In this case, since capacitor 10a is less likely to come into contact with housing 30 and heat dissipation plate 40 during assembly, damage to capacitor 10a can be suppressed. When substrate 60 is in contact with side wall 31, the heat generated in capacitor 10a and transferred to substrate 60 is easily transferred to side wall 31 and dissipated from side wall 31. Thus, in this case, the temperature rise in capacitor 10a can be further suppressed.

When electrode surface 11a on the side opposite to first portion 41 in capacitor 10a belonging to the first column (the second column) is substantially parallel to the inner wall surface of third side wall portion 31c (fourth side wall portion 31d), the thermal resistance between electrode surface 11a and side wall 31 can be equalized. When the bottom surface of capacitor 10a is substantially parallel to the inner wall surface of bottom wall 32, the thermal resistance between capacitor 10a and bottom wall 32 can be equalized.

In power conversion device 100, since heat dissipation plate 40 is disposed between adjacent capacitors 10a, heat dissipation plate 40 functions as an electromagnetic shield between these adjacent capacitors 10a. Further, heat dissipation plate 40 is disposed between adjacent capacitors 10a, and thereby, functions also as a fire prevention wall when capacitors 10a break down and explode.

### First Modification

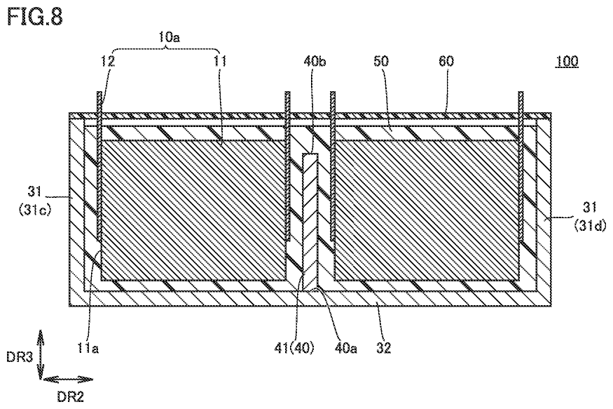

FIG. 8 is a cross-sectional view of a power conversion device 100 according to the first modification. FIG. 8 shows a cross section at a position corresponding to IV-IV in FIG. 2. As shown in FIG. 8, capacitor 10a may not have outer case 13 and resin 14. Even if capacitor 10a does not have outer case 13 and resin 14, capacitor element 11 can be insulated by heat transfer member 50.

In this case, since heat is directly transferred from capacitor element 11 to heat transfer member 50, the heat transfer resistance between capacitor 10a and heat dissipation plate 40 decreases, with the result that the temperature rise in capacitor 10a can be further suppressed. In this case, capacitor 10a can be reduced in size, so that power conversion device 100 can also be reduced in size. Further, in this case, capacitor element 11 can be increased in size while maintaining the size of power conversion device 100, so that capacitor 10a can be increased in capacity.

### Second Modification

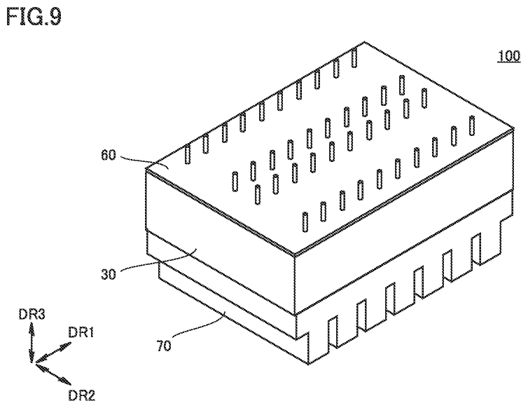

FIG. 9 is a perspective view of a power conversion device 100 according to the second modification. As shown in FIG. 9, power conversion device 100 may further include a cooler. The cooler is a heat sink 70, for example. Heat sink 70 is attached to the outside of housing 30. More specifically, heat sink 70 is attached to bottom wall 32. By introducing a coolant such as water or air to flow through heat sink 70, this heat sink 70 may be cooled. Heat sink 70 is made of a material having high thermal conductivity. Heat sink 70 is, for example, made of copper, aluminum, iron, or the like. Heat sink 70 has fin portions, for example, each having a plate shape or a needle-like protruding shape. The fin portions of heat sink 70 extend, for example, in third direction DR3. The plate-shaped fin portions of heat sink 70 may be arranged in first direction DR1 as shown in FIG. 9 or may be arranged in second direction DR2. The thickness, number, and length of the fin portions of heat sink 70 may be changed as appropriate depending on the coolant (water, air, and the like) or the cooling method.

For implementing a much higher output of power conversion device 100, the number of capacitors 10a increases. When capacitors 10a are arranged in three or more columns, the number of capacitors 10a adjacent to each other in first direction DR1 and the number of capacitors 10a adjacent to each other in second direction DR2 increase, so that the temperature rise in capacitors 10a increases. In the case where only dissipation of heat from housing 30 to air is insufficient, the cooling needs to be promoted by heat sink 70. For example, heat sink 70 is disposed on the outer wall surface of bottom wall 32. When power conversion device 100 includes heat sink 70, the heat transferred to housing 30 (side wall 31 and bottom wall 32) is dissipated from heat sink 70, so that the temperature rise in capacitor 10a can be further suppressed.

### Third Modification

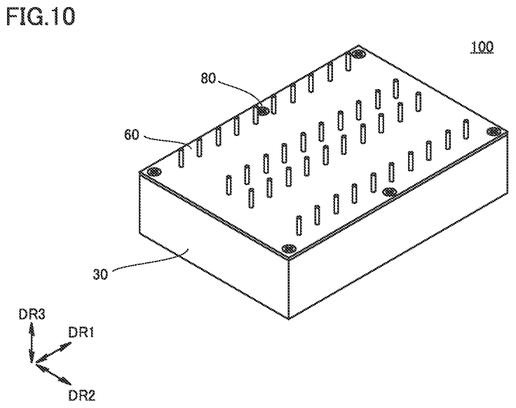

FIG. 10 is a perspective view of a power conversion device 100 according to the third modification. As shown in FIG. 10, power conversion device 100 may include a screw 80. Screw 80 is, for example, a countersunk head screw or a pan-head screw. Screw 80 is inserted through a through hole 60b (not shown in FIG. 10) provided in substrate 60 and screwed into a screw hole provided in side wall 31. Thereby, substrate 60 is fixed to side wall 31. Screw 80 may be a rivet. The method of fixing substrate 60 to side wall 31 is not limited to screwing. Substrate 60 may be fixed to side wall 31 by bonding, caulking, welding, or the like.

In the above-mentioned configuration, fixing substrate 60 to side wall 31 prevents a substantially non-parallel state between electrode surface 11a on the first portion 41 side in capacitor 10a belonging to the first column (the second column) and side surface 40c (side surface 40d) of first portion 41. As a result, the thermal resistance between electrode surface 11a and heat dissipation plate 40 can be equalized.

Further, the above-mentioned configuration prevents a substantially non-parallel state between electrode surface 11a on the side opposite to first portion 41 in capacitor 10a belonging to the first column (the second column) and the inner wall surface of third side wall portion 31c (fourth side wall portion 31d), and also prevents a substantially non-parallel state between the bottom surface of capacitor 10a and the inner wall surface of bottom wall 32. This consequently makes it possible to equalize: the thermal resistance between electrode surface 11a and side wall 31: and the thermal resistance between capacitor 10a and bottom wall 32.

Further, in this case, as a result of the positioning of substrate 60, capacitors 10a are also positioned in housing 30, so that the assembly performance for power conversion device 100 is improved.

### Fourth Modification

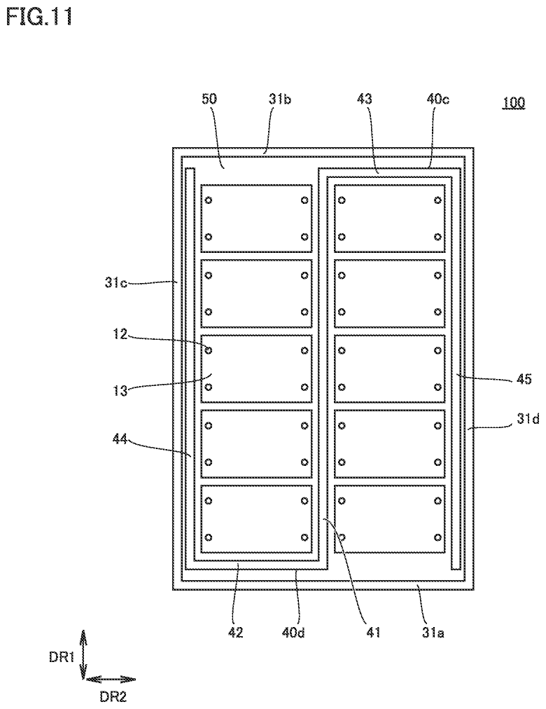

FIG. 11 is a plan view of a power conversion device 100 according to the fourth modification in which substrate 60 is not shown. As shown in FIG. 11, heat dissipation plate 40 may further include a fourth portion 44 and a fifth portion 45.

Fourth portion 44 and fifth portion 45 extend in first direction DR1. Fourth portion 44 is connected to an end of second portion 42 on the side opposite to first portion 41. Fifth portion 45 is connected to an end of third portion 43 on the side opposite to first portion 41. From a different point of view, fourth portion 44 faces electrode surface 11a on the side opposite to first portion 41 in capacitor 10a belonging to the first column, and fifth portion 45 faces electrode surface 11a on the side opposite to first portion 41 in capacitor 10a belonging to the second column.

In this case, the heat generated at electrode surface 11a on the side opposite to first portion 41 in capacitor 10a is also easily dissipated to heat dissipation plate 40. As a result, the temperature of the heat generated at electrode surface 11a on the side opposite to first portion 41 can be equalized by heat dissipation plate 40 and then dissipated from side wall 31, and thus, the heat dissipation performance is improved, so that the temperature rise in capacitor 10a can be further suppressed. Further, in this case, since the area of contact between heat dissipation plate 40 and bottom wall 32 further increases, the contact thermal resistance between heat dissipation plate 40 and bottom wall 32 can be further reduced, so that the temperature rise in capacitor 10a can be further suppressed.

### Second Embodiment

A power conversion device according to the second embodiment will be described. The power conversion device according to the second embodiment will be referred to as a power conversion device 100A. In the following description, the differences from power conversion device 100 will be mainly explained, and the same description will not be repeated.

### Configuration of Power Conversion Device 100A

The configuration of power conversion device 100A will be described below.

Power conversion device 100A includes a plurality of circuit components 10 (capacitors 10a), housing 30, heat transfer member 50, and substrate 60. In this respect, the configuration of power conversion device 100A is the same as that of power conversion device 100.

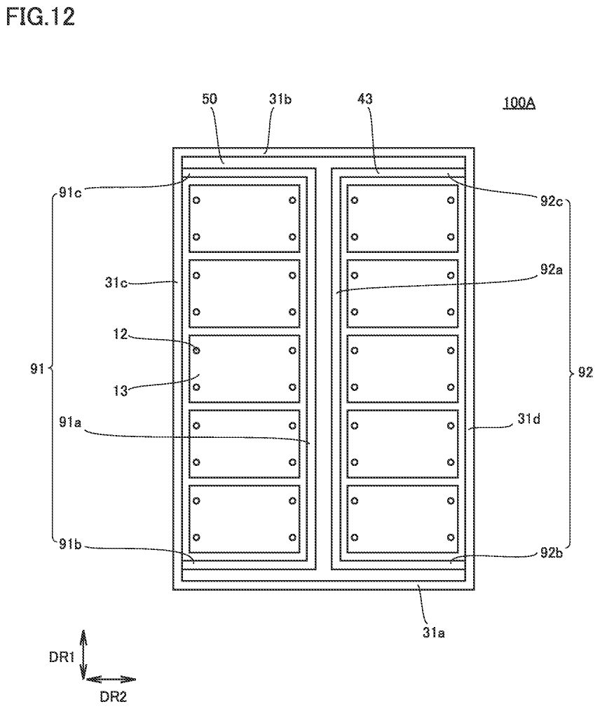

FIG. 12 is a plan view of power conversion device 100A in which substrate 60 is not shown. As shown in FIG. 12, power conversion device 100A includes heat dissipation plates 91 and 92 in place of heat dissipation plate 40. In this respect, power conversion device 100A is different in configuration from power conversion device 100.

Heat dissipation plates 91 and 92 are adjacent to each other in second direction DR2. Heat dissipation plate 91 includes a first portion 91a, a second portion 91b, and a third portion 91c. Heat dissipation plate 92 includes a first portion 92a, a second portion 92b, and a third portion 92c.

First portion 91a extends in first direction DR1. Second portion 91b and third portion 91c extend in second direction DR2 from respective ones of both ends of first portion 91a toward third side wall portion 31c. First portion 92a extends in first direction DR1. Second portion 92b and third portion 92c extend in second direction DR2 from respective ones of both ends of first portion 92a toward fourth side wall portion 31d.

First portions 91a and 92a are disposed between capacitors 10a belonging to the first column and capacitors 10a belonging to the second column. Electrode surface 11a on the first portion 91a side in capacitor 10a belonging to the first column faces first portion 91a. Electrode surface 11a on the first portion 92a side in capacitor 10a belonging to the second column faces first portion 92a.

The sum of the width of heat dissipation plate 91 in second direction DR2 and the width of heat dissipation plate 92 in second direction DR2 is most preferably equal to the distance in second direction DR2 between third side wall portion 31c and fourth side wall portion 31d. The value obtained by subtracting the sum of the width of heat dissipation plate 91 in second direction DR2 and the width of heat dissipation plate 92 in second direction DR2 from the distance in second direction DR2 between third side wall portion 31c and fourth side wall portion 31d may be smaller than 0.5 mm.

The effects of power conversion device 100A will be described below.

In power conversion device 100, both the heat generated in capacitors 10a belonging to the first column and the heat generated in capacitors 10a belonging to the second column are transferred to heat dissipation plate 40 through heat transfer member 50, and thus, the temperature in heat dissipation plate 40 easily rises. On the other hand, in power conversion device 100A, the heat generated in capacitors 10a belonging to the first column is transferred to heat dissipation plate 91 while the heat generated in capacitors 10a belonging to the second column is transferred to heat dissipation plate 92. Thus, according to power conversion device 100A, the temperature rise in capacitor 10a can be further suppressed and the temperature can be further equalized among the plurality of capacitors 10a.

When the sum of the width of heat dissipation plate 91 in second direction DR2 and the width of heat dissipation plate 92 in second direction DR2 is equal to the distance in second direction DR2 between third side wall portion 31c and fourth side wall portion 31d, or when the value obtained by subtracting the sum of the width of heat dissipation plate 91 in second direction DR2 and the width of heat dissipation plate 92 in second direction DR2 from the distance in second direction DR2 between third side wall portion 31c and fourth side wall portion 31d is smaller than 0.5 mm, heat dissipation plates 91 and 92 can be positioned in housing 30. Positioning of heat dissipation plates 91 and 92 facilitates positioning of capacitors 10a, so that the assembly performance for power conversion device 100A is improved.

### First Modification

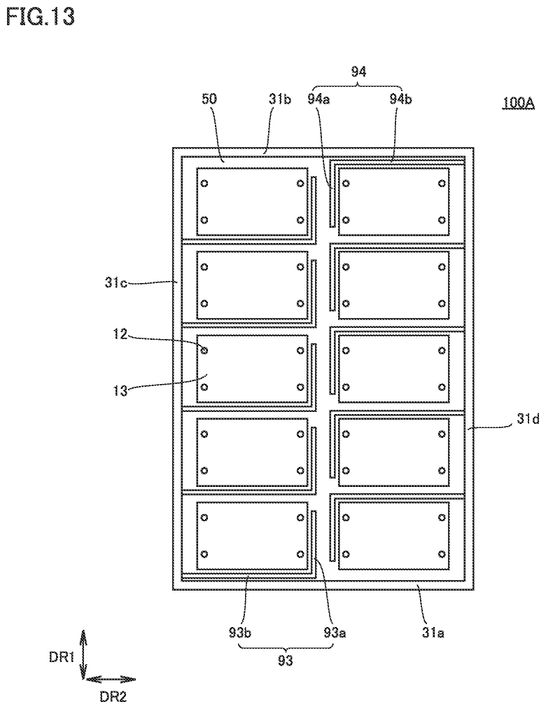

FIG. 13 is a plan view of a power conversion device 100A according to the first modification in which substrate 60 is not shown. As shown in FIG. 13, power conversion device 100A may include a plurality of heat dissipation plates 93 and a plurality of heat dissipation plates 94 in place of heat dissipation plates 91 and 92. Heat dissipation plate 93 has an L-shape in a plan view. Heat dissipation plate 93 includes a first portion 93a and a second portion 93b. First portion 93a extends in first direction DR1. Second portion 93b extends in second direction DR2 from one end of first portion 93a in first direction DR1 toward third side wall portion 31c.

First portion 93a is disposed between two capacitors 10a adjacent to each other in second direction DR2. Second portion 93b is disposed between two capacitors 10a belonging to the first column and adjacent to each other in first direction DR1. Note that second portion 93b of heat dissipation plate 93 that is closest to first side wall portion 31a is disposed between first side wall portion 31a and capacitor 10a belonging to the first column and closest to first side wall portion 31a.

Heat dissipation plate 94 has an L-shape in a plan view. Heat dissipation plate 94 includes a first portion 94a and a second portion 94b. First portion 94a extends in first direction DR1. Second portion 94b extends in second direction DR2 from the other end of first portion 94a in first direction DR1 toward fourth side wall portion 31d. Heat dissipation plate 94 preferably has the same shape as heat dissipation plate 93.

First portion 94a is disposed between two capacitors 10a adjacent to each other in second direction DR2. First portion 94a is located closer to capacitor 10a belonging to the second column than first portion 93a is. Second portion 94b is disposed between two capacitors 10a belonging to the second column and adjacent to each other in first direction DR1. Note that second portion 94b of heat dissipation plate 94 that is closest to second side wall portion 31b is disposed between second side wall portion 31b and capacitor 10a belonging to the second column and closest to second side wall portion 31b.

In this case, one heat dissipation plate 93 or one heat dissipation plate 94 is disposed for one capacitor 10a. As a result, the area of heat transfer from capacitor 10a to the heat dissipation plate increases, and the thermal resistance between capacitor 10a and the heat dissipation plate decreases, so that the temperature rise in capacitor 10a is further suppressed. Further, heat dissipation plates 93 and 94 each have a simple shape and thereby can be easily processed. When heat dissipation plates 93 and 94 have the same shape, the productivity is particularly improved. Further, since at least one of heat dissipation plates 93 and 94 is disposed between two adjacent capacitors 10a, the function as a fire prevention wall applied when capacitors 10a break down and explode is further improved.

### Second Modification

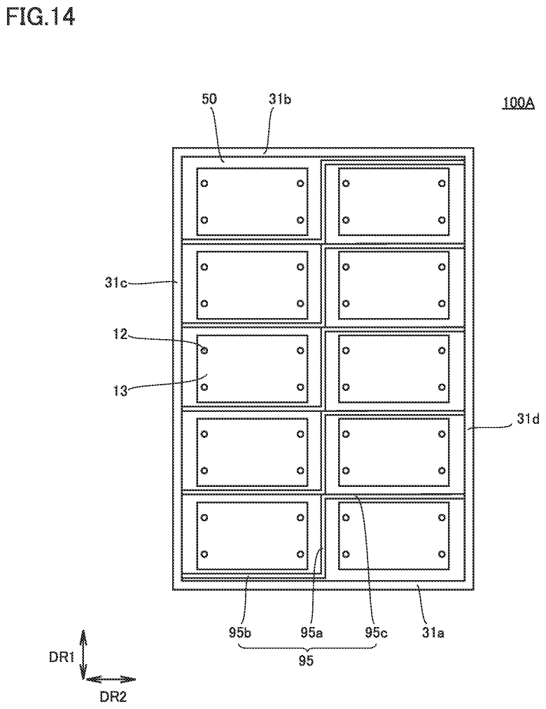

FIG. 14 is a plan view of a power conversion device 100A according to the second modification in which substrate 60 is not shown. As shown in FIG. 14, power conversion device 100A may include a plurality of heat dissipation plates 95 in place of heat dissipation plates 91 and 92. The plurality of heat dissipation plate plates 95 preferably have the same shape. Heat dissipation plate 95 includes a first portion 95a, a second portion 95b, and a third portion 95c.

First portion 95a extends in first direction DR1 between two capacitors 10a adjacent to each other in second direction DR2. Second portion 95b extends in second direction DR2 from one end of first portion 95a in first direction DR1 toward third side wall portion 31c. Third portion 95c extends in second direction DR2 from the other end of first portion 95a in first direction DR1 toward fourth side wall portion 31d.

Second portion 95b is disposed between two capacitors 10a belonging to the first column and adjacent to each other in first direction DR1. Note that second portion 95b of heat dissipation plate 95 that is closest to first side wall portion 31a is disposed between first side wall portion 31a and capacitor 10a belonging to the first column and closest to first side wall portion 31a. Third portion 95c is disposed between two capacitors 10a belonging to the second column and adjacent to each other in first direction DR1. Note that third portion 95c of heat dissipation plate 95 that is closest to second side wall portion 31b is disposed between second side wall portion 31b and capacitor 10a belonging to the second column and closest to second side wall portion 31b.

Also in this case, similarly to the case where power conversion device 100A includes the plurality of heat dissipation plates 93 and the plurality of heat dissipation plates 94, the area of heat transfer from capacitor 10a to each heat dissipation plate increases and the thermal resistance between capacitor 10a and each heat dissipation plate decreases, so that the temperature rise in capacitor 10a is further suppressed. Further, when the plurality of heat dissipation plates 95 have the same shape, the productivity is improved. Further, since heat dissipation plate 95 is located between two adjacent capacitors 10a, the function as a fire prevention wall applied when capacitors 10a break down and explode is further improved.

### Third Embodiment

A power conversion device according to the third embodiment will be described below. The power conversion device according to the third embodiment will be referred to as a power conversion device 100B. In the following description, the differences from power conversion device 100 will be mainly explained, and the same description will not be repeated.

### Configuration of Power Conversion Device 100B

The configuration of power conversion device 100B will be described below.

Power conversion device 100A includes a plurality of circuit components 10 (capacitors 10a), housing 30, heat transfer member 50, substrate 60, and screw 80. In this respect, power conversion device 100B is identical in configuration to power conversion device 100.

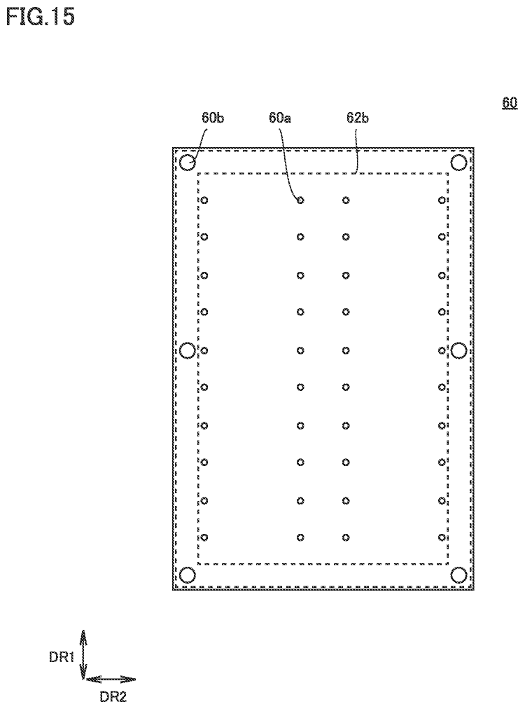

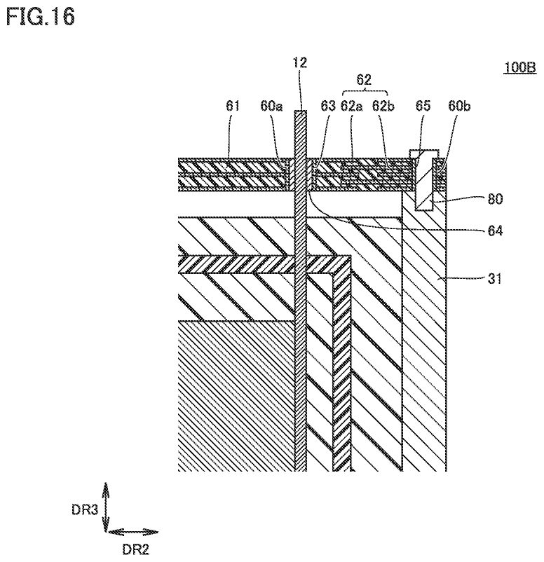

FIG. 15 is a plan view of substrate 60 included in power conversion device 100B. FIG. 16 is an enlarged cross-sectional view of power conversion device 100B.

FIG. 16 shows an enlarged cross section at a position corresponding to IV-IV in FIG. 2. As shown in FIGS. 15 and 16, in power conversion device 100B, wiring member 62 includes a first wiring member 62a and a second wiring member 62b. In power conversion device 100B, substrate 60 includes a conductor layer 65. As to the above-mentioned points, power conversion device 100B is different in configuration from power conversion device 100.

First wiring member 62a is connected to conductor layer 63. Thus, first wiring member 62a is electrically connected to current-carrying terminal 12 by conductor layer 63 and bonding member 64. First wiring member 62a is exposed on the surface of substrate 60. Second wiring member 62b is electrically insulated from first wiring member 62a. Thus, second wiring member 62b is electrically insulated from current-carrying terminal 12. First wiring member 62a and second wiring member 62b overlap with each other with base member 61 interposed therebetween in a plan view. Thus, first wiring member 62a and second wiring member 62b are thermally connected. Conductor layer 65 is disposed on the inner wall surface of through hole 60b. Second wiring member 62b is connected to conductor layer 65. Screw 80 is in contact with conductor layer 65.

### Effects of Power Conversion Device 100B

The effects of power conversion device 100B will be described below. In power conversion device 100B, the heat generated in capacitor 10a is transferred to first wiring member 62a through current-carrying terminal 12, conductor layer 63, and bonding member 64. Since first wiring member 62a and second wiring member 62b are thermally connected, the heat is further transferred to side wall 31 through second wiring member 62b, conductor layer 65, and screw 80. In this way, in power conversion device 100B, the thermal resistance of the heat transfer path through which the heat generated in capacitor 10a is transferred to housing 30 through substrate 60 decreases, so that the temperature rise in capacitor 10a can be further suppressed. Further, since substrate 60 includes conductor layers 63 and 65, the strength of substrate 60 increases, so that warpage of substrate 60 is suppressed.

### First Modification

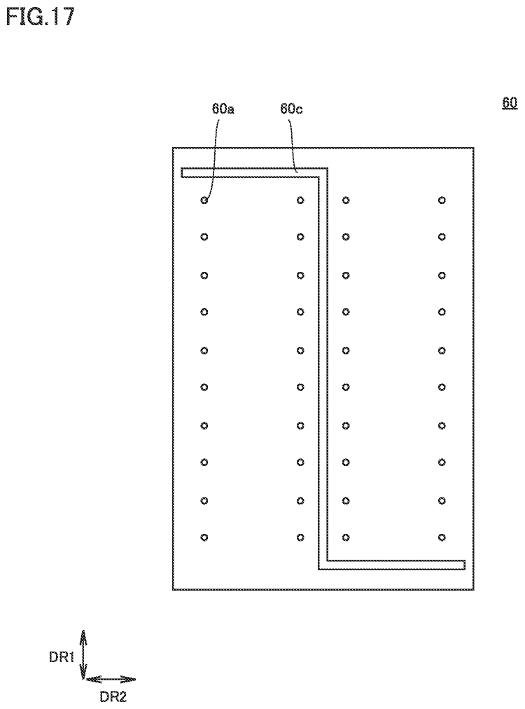

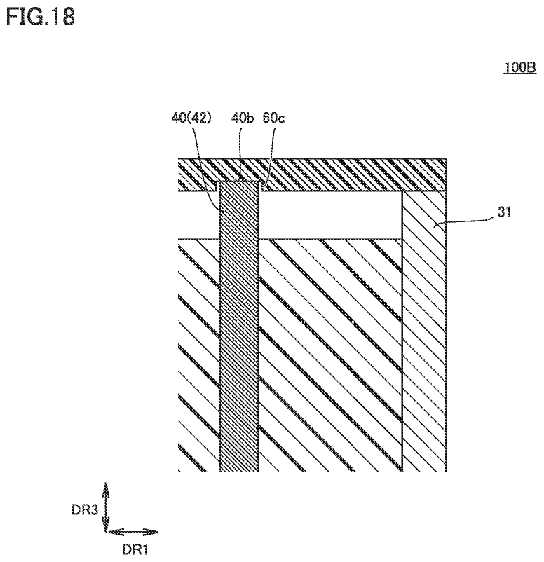

FIG. 17 is a bottom view of a substrate 60 included in a power conversion device 100B according to the first modification. FIG. 18 is an enlarged cross-sectional view of power conversion device 100B according to the first modification. FIG. 18 shows an enlarged cross section located in the vicinity of second portion 42 and orthogonal to second direction DR2. As shown in FIGS. 17 and 18, a groove 60c may be provided on the surface of substrate 60 that faces heat dissipation plate 40. Heat dissipation plate 40 (upper end 40b) may be in contact with the bottom surface of groove 60c. In other words, heat dissipation plate 40 is thermally connected to substrate 60. In this case, since heat dissipation plate 40 is thermally connected to substrate 60, the performance of heat dissipation from heat dissipation plate 40 to substrate 60 and the performance of heat dissipation from substrate 60 to heat dissipation plate 40 are improved, and thus, the temperature rise in capacitor 10a is further suppressed.

Heat dissipation plate 40 is preferably fitted in groove 60c. In this case, since heat dissipation plate 40 and substrate 60 are firmly fixed, the vibration resistance of power conversion device 100B is improved.

### Second Modification

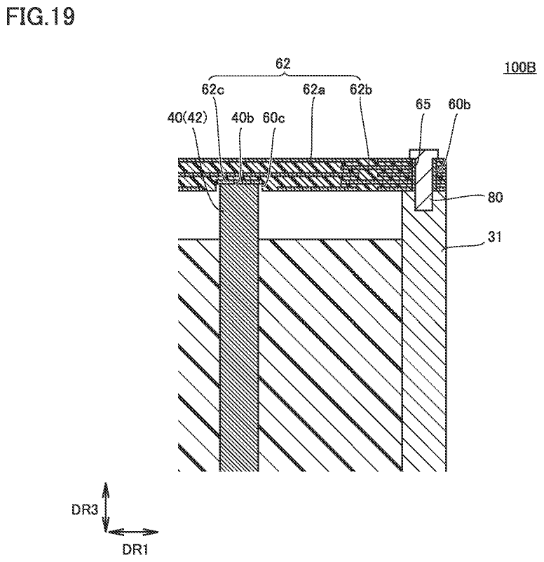

FIG. 19 is an enlarged cross-sectional view of a power conversion device 100B according to the second modification. FIG. 19 shows an enlarged cross section located in the vicinity of second portion 42 and orthogonal to second direction DR2. As shown in FIG. 19, wiring member 62 may further include a third wiring member 62c. Third wiring member 62c is exposed from the bottom surface of groove 60c. Third wiring member 62c is in contact with heat dissipation plate 40 (upper end 40b). Third wiring member 62c is electrically insulated from first wiring member 62a. Since third wiring member 62c overlaps with first wiring member 62a in a plan view, third wiring member 62c is thermally connected to first wiring member 62a.

Thus, in this case, the heat of capacitor 10a is transferred to third wiring member 62c through heat dissipation plate 40, and this heat is transferred to first wiring member 62a. This heat is further transferred to side wall 31 (housing 30) through second wiring member 62b, conductor layer 65, and screw 80. Further, in this case, the heat transferred from capacitor 10a to side wall 31 through heat transfer member 50 is transferred to heat dissipation plate 40 through screw 80, conductor layer 65, second wiring member 62b, and third wiring member 62c. Thus, in this case, the temperature rise in capacitor 10a can be further suppressed.

### Fourth Embodiment

A power conversion device according to the fourth embodiment will be described. The power conversion device according to the fourth embodiment will be referred to as a power conversion device 100C. In the following description, the differences from power conversion device 100 will be mainly explained, and the same description will not be repeated.

### Configuration of Power Conversion Device 100C

The configuration of power conversion device 100C will be described below.

Power conversion device 100C includes a plurality of circuit components 10

(capacitors 10a), housing 30, heat transfer member 50, and substrate 60. In this respect, the configuration of power conversion device 100C is identical in configuration to power conversion device 100.

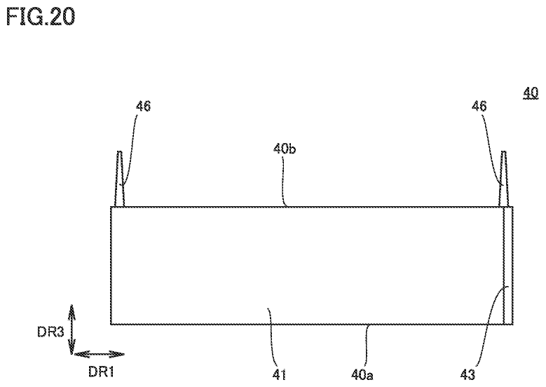

FIG. 20 is a side view of a heat dissipation plate 40 included in power conversion device 100C. As shown in FIG. 20, in power conversion device 100C, heat dissipation plate 40 has a protrusion 46. Protrusion 46 protrudes from upper end 40b in third direction DR3. Protrusion 46 may be located at any position on upper end 40b. The number of protrusions 46 is preferably more than one. The larger number of protrusions 46 is more preferable. Protrusion 46 may be formed integrally with heat dissipation plate 40, or may be attached to heat dissipation plate 40 by soldering, welding, caulking, or the like. The material of protrusion 46 may be the same as or different from the material of heat dissipation plate 40.

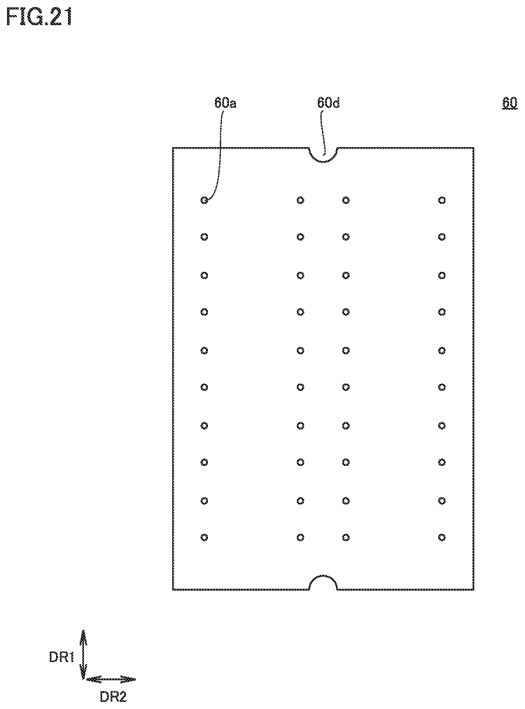

FIG. 21 is a plan view of substrate 60 included in power conversion device 100C. As shown in FIG. 21, in power conversion device 100C, substrate 60 is provided with a through hole 60d. Through hole 60d may be provided at the outer peripheral edge of substrate 60 in a plan view. In other words, through hole 60d may be a notch. The number of through holes 60d is equal to the number of protrusions 46. Protrusion 46 protrudes from substrate 60 through the through hole 60d in the state in which substrate 60 is disposed on housing 30. Protrusion 46 preferably protrudes so long that protrusion 46 protrudes by a large amount from substrate 60. In these respects, power conversion device 100C is different in configuration from power conversion device 100.

### Effects of Power Conversion Device 100C

The effects of power conversion device 100C will be described below.

In power conversion device 100C, heat dissipation plate 40 has protrusion 46 and substrate 60 is provided with through hole 60d, which facilitates positioning of substrate 60 with respect to heat dissipation plate 40. In addition, since substrate 60 can be positioned with respect to heat dissipation plate 40, the distance between heat dissipation plate 40 and capacitor 10a or the distance between capacitor 10a and side wall 31 is less likely to vary, and thus, the temperature in housing 30 can be equalized. Further, the heat generated in capacitor 10a and transferred to heat dissipation plate 40 is further transferred to protrusion 46 and dissipated from protrusion 46, so that the temperature rise in capacitor 10a can be further suppressed.

### Fifth Embodiment

A power conversion device according to the fifth embodiment will be described. The power conversion device according to the fifth embodiment will be referred to as a power conversion device 100D. In the following description, the differences from power conversion device 100 will be mainly explained, and the same description will not be repeated.

### Configuration of Power Conversion Device 100D

The configuration of power conversion device 100D will be described below.

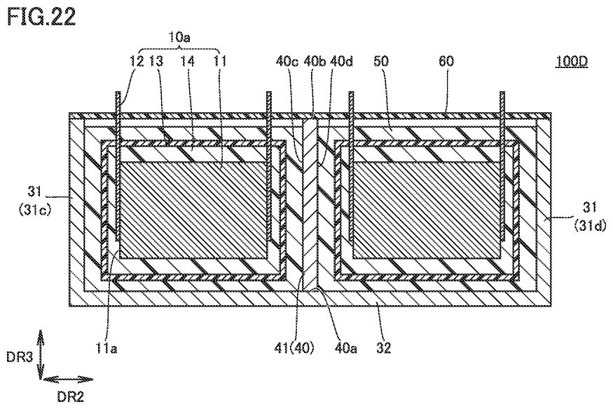

FIG. 22 is a cross-sectional view of power conversion device 100D. As shown in FIG. 22, in power conversion device 100D, heat dissipation plate 40 may be connected at upper end 40b to substrate 60. This connection is performed, for example, by screwing, bonding, caulking, welding, or the like.

### Effects of Power Conversion Device 100D

The effects of power conversion device 100D will be described below. In power conversion device 100D, since heat dissipation plate 40 is connected

to substrate 60, the heat dissipation path for the heat of capacitor 10a increases. In other words, in power conversion device 100D, the heat of capacitor 10a is transferred from electrode surface 11a through heat transfer member 50 and heat dissipation plate 40 and dissipated from bottom wall 32, then transferred from current-carrying terminal 12 through substrate 60 and dissipated from side wall 31, and transferred from current-carrying terminal 12 through heat dissipation plate 40 and substrate 60 and dissipated from bottom wall 32. In power conversion device 100D, since heat dissipation plate 40 is connected to substrate 60 that is supported by heat dissipation plate 40, the deformation of substrate 60 resulting from the weight of capacitor 10a is suppressed.

### First Modification

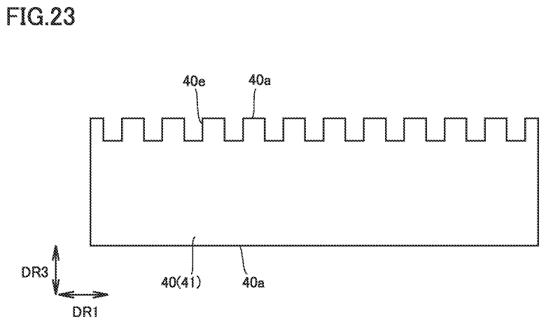

FIG. 23 is one example of a side view of heat dissipation plate 40 included in power conversion device 100D according to the first modification. As shown in FIG. 23, in power conversion device 100D, upper end 40b may be provided with a plurality of grooves 40e. The bottom portion of each groove 40e is located below the upper surface of heat transfer member 50. In other words, heat dissipation plate 40 is embedded in heat transfer member 50 at a portion where groove 40e is formed. When heat dissipation plate 40 is connected to substrate 60, heat transfer member 50 is located in an unbalanced manner in housing 30, and thus, the temperature rise in capacitor 10a may increase. However, when upper end 40b is provided with groove 40e and the bottom portion of groove 40e is located below the upper surface of heat transfer member 50, then in heat transfer member disposing step S2, heat transfer member 50 before curing moves through groove 40e, so that heat transfer member 50 fills housing 30 in a balanced manner and the temperature in capacitor 10a is equalized.

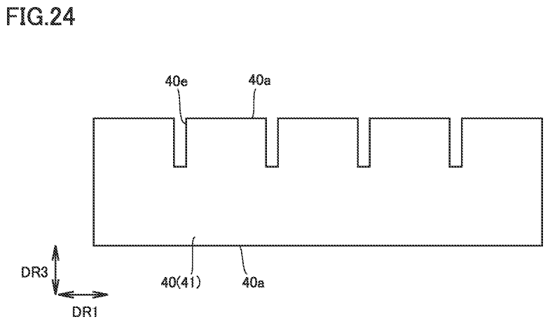

FIG. 24 is another example of the side view of heat dissipation plate 40 included in power conversion device 100D according to the first modification. As shown in FIG. 24, since the heat of capacitor 10a is dissipated from housing 30 through heat dissipation plate 40, groove 40e is preferably provided at a position at which it does not face electrode surface 11a. Too deep groove 40e reduces the heat conduction in the longitudinal direction of heat dissipation plate 40. Accordingly, the bottom portion of groove 40e is preferably located above heat transfer member 50 and above the intermediate position between lower end 40a and upper end 40b.

### Second Modification

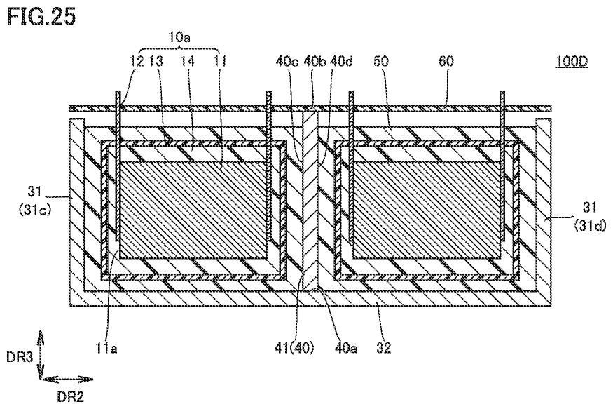

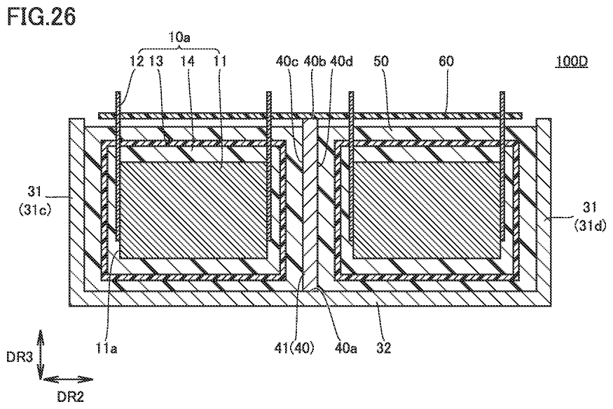

FIG. 25 is one example of a cross-sectional view of a power conversion device 100D according to the second modification. FIG. 26 is another example of the cross-sectional view of power conversion device 100D according to the second modification. As shown in FIGS. 25 and 26, a gap is preferably present between the upper portion of side wall 31 and substrate 60. More specifically, when substrate 60 is larger in size than bottom wall 32, there is a gap between the upper portion of side wall 31 and substrate 60 in third direction DR3 as shown in FIG. 25. In the example shown in FIG. 25, when substrate 60 needs to be positioned with respect to side wall 31 with severe accuracy, although not shown, substrate 60 may be screwed onto side wall 31 in the state in which a spacer is inserted between substrate 60 and side wall 31. When substrate 60 is smaller in size than bottom wall 32, a gap is present, for example, between the upper portion of side wall 31 and substrate 60 in second direction DR2 as shown in FIG. 26.

Due to a gap between the upper portion of side wall 31 and substrate 60, the heat of capacitor 10a is less likely to be retained in housing 30, so that the temperature rise in capacitor 10a can be suppressed. Further, due to a gap between the upper portion of side wall 31 and substrate 60, it can be checked through this gap whether or not heat transfer member 50 fills housing 30.

It should be understood that the embodiments disclosed herein are illustrative and non-restrictive in every respect. The basic scope of the present disclosure is defined by the terms of the claims, rather than the embodiments described above, and is intended to include all modifications within the meaning and scope equivalent to the terms of the claims.

### REFERENCE SIGNS LIST

100 power conversion device, 10 circuit component, 10a capacitor, 10b inductor, 10c contactor, 10d discharge resistor, 10e charge resistor, 11 capacitor element, 11a electrode surface, 12 current-carrying terminal, 13 outer case, 14 resin, 20 circuit component, 20a, 20b, 20c, 20d, 20e, 20f transistor, 20g, 20h, 20i, 20j, 20k, 20l diode, 30 housing, 31 side wall, 31a first side wall portion, 31b second side wall portion, 31c third side wall portion, 31d fourth side wall portion, 32 bottom wall, 40 heat dissipation plate, 40a lower end, 40b upper end, 40c, 40d side surface, 40e groove, 41 first portion, 42 second portion, 43 third portion, 44 fourth portion, 45 fifth portion, 46 protrusion, 50 heat transfer member, 60 substrate, 60a through hole, 60b through hole, 60c groove, 60d through hole, 61 base member, 62 wiring member, 62a first wiring member, 62b second wiring member, 62c third wiring member, 63 conductor layer, 64 bonding member, 65 conductor layer, 70 heat sink, 80 screw, 91 heat dissipation plate, 91a first portion, 91b second portion, 91c third portion, 92 heat dissipation plate, 92a first portion, 92b second portion, 92c third portion, 93 heat dissipation plate, 93a first portion, 93b second portion, 94 heat dissipation plate, 94a first portion, 94b second portion, 95 heat dissipation plate, 95a first portion, 95b second portion, 95c third portion, 100A, 100B, 100C, 100D power conversion device, 110 peripheral circuit, 120 switching circuit, 130 DC supply circuit, 140 motor, 141, 142, 143 input line, DR1 first direction, DR2 second direction, DR3 third direction, S1 circuit component connecting step, S2 heat transfer member disposing step, S3 heat dissipation plate/circuit component accommodating step.

1. A power conversion device comprising:
a housing;
a plurality of circuit components accommodated in the housing;
at least one heat dissipation plate accommodated in the housing; and
a substrate, wherein
each of the plurality of circuit components includes an element body and a current-carrying terminal electrically connected to an electrode surface of the element body,
the substrate is electrically connected to the current-carrying terminal
the at least one heat dissipation plate is disposed between two adjacent circuit components of the plurality of circuit components and thermally connected to the housing, and
each of the plurality of circuit components is disposed such that the electrode surface faces the at least one heat dissipation plate.

2. The power conversion device according to claim 1, wherein each of the at least one heat dissipation plate has at least one bent portion bent in a plan view.

3. The power conversion device according to claim 1, further comprising a heat transfer member disposed in the housing, wherein
the heat transfer member thermally connects the plurality of circuit components to the at least one heat dissipation plate.

4. The power conversion device according to claim 1, wherein
the element body is a capacitor element.

5. The power conversion device according to claim 1, wherein
the housing has a side wall, and
at least a part of each of the at least one heat dissipation plate faces the side wall.

6. The power conversion device according to claim 1, further comprising a cooler attached to an outside of the housing.

7. The power conversion device according to claim 1, wherein the substrate is fixed to the housing.

8. The power conversion device according to claim 1, wherein the at least one heat dissipation plate is provided as a plurality of heat dissipation plates.

9. The power conversion device according to claim 1, wherein
the substrate includes a first wiring member exposed on a surface of the substrate, and
the first wiring member is in contact with the housing.

10. The power conversion device according to claim 1, wherein
the substrate includes a first wiring member exposed on a surface of the substrate and a second wiring member electrically connected to the plurality of circuit components, and
the first wiring member is electrically insulated from the second wiring member.

11. The power conversion device according to any one of claims claim 1, wherein the substrate is provided with a groove that is in contact with the at least one heat dissipation plate.

12. The power conversion device according to claim 1, wherein
the substrate includes a third wiring member,
the substrate is provided with a first groove along which the third wiring member is exposed, and
the third wiring member is in contact with the at least one heat dissipation plate.

13. The power conversion device according to claim 1, wherein
the substrate is provided with a hole that passes through the substrate, and
each of the at least one heat dissipation plate has a protrusion that is inserted into the hole.

14. The power conversion device according to claim 1, wherein
the plurality of circuit components includes
a plurality of first circuit components arranged in a first column, and
a plurality of second circuit components arranged in a second column in a direction identical to a direction of the first column,
the electrode surface of each of the plurality of first circuit components faces the electrode surface of a corresponding one of the plurality of second circuit components, and
the at least one heat dissipation plate is one heat dissipation plate disposed between the plurality of first circuit components and the plurality of second circuit components.

15. The power conversion device according to claim 1, wherein the heat dissipation plate is connected to the substrate.

16. The power conversion device according to claim 15, wherein the heat dissipation plate has an upper end provided with a second groove.

17. The power conversion device according to claim 15, wherein
the housing has a side wall, and
a gap is present between an upper portion of the side wall and the substrate.

18-19. (canceled)

20. A power conversion device comprising:
a housing;
a plurality of circuit components accommodated in the housing;
at least one heat dissipation plate accommodated in the housing; and
a substrate, wherein
each of the plurality of circuit components includes an element body and a current-carrying terminal electrically connected to an electrode surface of the element body,
the substrate is electrically connected to the current-carrying terminal,
the at least one heat dissipation plate is disposed between two adjacent circuit components of the plurality of circuit components and thermally connected to the housing,
the substrate includes a first wiring member exposed on a surface of the substrate, and
the first wiring member is in contact with the housing.

21. A power conversion device comprising:
a housing;
a plurality of circuit components accommodated in the housing;
at least one heat dissipation plate accommodated in the housing; and
a substrate, wherein
each of the plurality of circuit components includes an element body and a current-carrying terminal electrically connected to an electrode surface of the element body,
the substrate is electrically connected to the current-carrying terminal,
the at least one heat dissipation plate is disposed between two adjacent circuit components of the plurality of circuit components and thermally connected to the housing,
the substrate includes a first wiring member exposed on a surface of the substrate and a second wiring member electrically connected to the plurality of circuit components, and
the first wiring member is electrically insulated from the second wiring member.
